(19) United States
(12) Patent Application Publication
(10) Pub. No.: US 2013/0301167 A1
(43) Pub. Date: Nov. 14, 2013

(54) TRANSFORMER ARRANGEMENT FOR WIND TURBINE AND METHOD FOR CONTROLLING VOLTAGE

(71) Applicant: Andre Langel, Stadtlohn (DE)

(72) Inventor: Andre Langel, Stadtlohn (DE)

(21) Appl. No.: 13/466,193

(22) Filed: May 8, 2012

(51) Int. Cl. H02H 7/06

(52) U.S. Cl. 361/21

(57) ABSTRACT

A transformer arrangement for a wind energy system is described. The transformer arrangement includes a transformer core; a primary winding wound around the transformer core and adapted for being connected to an electrical load; a first secondary winding wound around the transformer core and adapted for being connected to a power source; and a control system for controlling the first transformer. Further, the transformer arrangement includes a part of a second secondary winding adapted for being connected to a power source and adapted for reducing at least one of for the voltage of the first secondary winding and the voltage applied to the electrical components of the wind turbine in the case of an overvoltage event.

### BACKGROUND OF THE INVENTION

The subject matter described herein relates generally to methods and systems for a transformer of a wind turbine, and more particularly to methods and systems for controlling the voltage of a transformer.

Generally, a wind turbine includes a turbine that has a rotor, which includes a rotatable hub assembly having multiple blades. The blades transform wind energy into a mechanical rotational torque that drives one or more generators via the rotor. The generators are sometimes, but not always, rotationally coupled to the rotor through a gearbox. The gearbox steps up the inherently low rotational speed of the rotor for the generator to efficiently convert the rotational mechanical energy to electrical energy, which is fed into a utility grid via a wind turbine terminal (e.g., an electrical connection). Gearless direct drive wind turbines also exist. The rotor, generator, gearbox and other components are typically mounted within a housing, or nacelle, which is positioned on top of a base that may be a truss or tubular tower.

Some generators of wind turbines may also include power converters that are used to convert a frequency of generated electric power to a frequency substantially similar to a utility grid frequency. Alternatively, some wind turbine configurations include, but are not limited to, alternative types of induction generators, doubly-fed induction generators, permanent magnet (PM) synchronous generators, electrically-excited synchronous generators and switched reluctance generators. These alternative configurations may also include power converters that are used to convert the frequencies as described above and transmit electrical power between the utility grid and the generator.

Known wind turbines thus have a plurality of mechanical and electrical components. Each electrical and/or mechanical component may have independent or different operating limitations, such as current, voltage, power, and/or temperature limits, when compared with other components. Moreover, known wind turbines are designed and/or assembled with predefined rated power limits.

However, installing wind turbines all over the world creates the need for the wind turbine to meet a lot of different power grid codes. Some grid codes require overvoltage capability up to 180% of nominal voltage for several milliseconds. This overvoltage creates a risk for component damage, especially for power electronics. There are also increased requirements for low voltage ride through and broader voltage limits for continuous operation.

Thus, it is desirable to keep the wind turbine terminal voltage within a certain range in order to avoid component damage and increase the lifetime of the wind turbine's components.

### BRIEF DESCRIPTION OF THE INVENTION

In one aspect, a transformer arrangement for a wind energy system including electrical components is described. The transformer arrangement may include a first transformer including a transformer core, a primary winding wound around the transformer core and adapted for being connected to an electrical load, and a a first secondary winding wound around the transformer core and adapted for being connected to a first power source. Further, the transformer arrangement may includes a control system for controlling the first transformer and a second secondary winding adapted for being connected to a second power source and adapted for reducing at least one of the voltage of the first secondary winding and the voltage applied to the electrical components of the wind turbine.

In another aspect, a wind energy system is described including a rotor, a generator being connected to the rotor, and a terminal for connecting the wind energy system with a power grid. The wind energy system typically includes a transformer for reducing the voltage at the terminal including a transformer core, a primary winding wound around the transformer core and being connected to an electrical load, and a first secondary winding wound around the transformer core and adapted for being connected to the generator. Further, the wind energy system includes a winding device including at least one winding for reducing at least one of the voltage of the first secondary winding and the voltage applied to the terminal of the wind turbine, wherein the device is adapted for being connected to a power source. Typically, the wind energy system further includes a control system adapted for controlling the operation of at least one of t the first secondary winding and the winding device

In yet another aspect, a method for controlling a voltage in a transformer of a transformer arrangement of a wind energy system is described, wherein the wind energy system includes electrical components. The method may include providing a connection of a primary winding of the transformer to an electrical load, energizing a first secondary winding of the transformer for creating a first energy field, and energizing a second secondary winding of the transformer arrangement for reducing at least one of the voltage of the first secondary winding and the voltage applied to the electrical components of the wind turbine.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of a portion of an exemplary wind turbine.

FIG. 2 is a schematic view of an exemplary electrical and control system suitable for use with the wind turbine shown in FIG. 1.

FIG. 3 is a schematic view of a transformer according to embodiments described herein.

FIG. 4 is a schematic view of a transformer arrangement according to embodiments described herein.

FIG. 5 is a schematic view of a transformer arrangement according to embodiments described herein.

FIG. 6 is a schematic view of a transformer arrangement according to embodiments described herein.

FIG. 7 is a flow chart of a method for controlling a voltage in a transformer according to embodiments described herein.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include a system that reduces the risk of damage to any electrical component in the wind turbine. Further, the use of tripping protection devices can also be reduced, which saves costs. In addition, overvoltage events can be counteracted in a very fast (such as within the range of milliseconds) and reliable way. Generally, a voltage range of 90%-110% of nominal voltage is seen as the normal deviation for continuous operation. In this context and according to embodiments described herein, any voltage above about 110% of the nominal voltage should be understood as an overvoltage. Typically, an overvoltage event should be understood as the event in the case that an overvoltage occurs in the power grid. An overvoltage event may influence the voltage in the electrical components of the wind energy system and may cause an increase in the voltage in the electrical components of the wind energy system. An overvoltage event may be sensed by monitoring the voltage in the electrical components of the wind energy system due to the increase of voltage in the electrical components during an overvoltage event.

As used herein, the term “blade” is intended to be representative of any device that provides a reactive force when in motion relative to a surrounding fluid. As used herein, the term “wind turbine” is intended to be representative of any device that generates rotational energy from wind energy, and more specifically converts kinetic energy of wind into mechanical energy. As used herein, the term “wind generator” is intended to be representative of any wind turbine that generates electrical power from rotational energy generated from wind energy, and more specifically converts mechanical energy converted from kinetic energy of wind to electrical power. Further, the term “wind energy system” is exemplarily used for a system including one or more wind turbines.

As used herein, the term “transformer” is intended to be representative of a device capable of transferring electrical energy from one circuit to another. Typically, the electrical energy is transferred through inductively coupled conductors, such as transformer coils. Generally, two conductors are provided in a transformer, one of which is connected to a power source and is capable of influencing the voltage in the other conductor. Typically, the second conductor is connected to a load. As used herein, the term “winding” should be understood as a piece of conducting material being at least partly arranged around another component of a transformer. For instance, a wire made of conducting material may be formed as a winding being wound around a transformer core. Typically, a transformer core may provide one or more brackets, at which conductors of a transformer may be arranged. As used herein, the term “electrical component” may refer to any electrical component in the wind turbine. For instance, electrical components may be present in the circuitry of the wind turbine. Examples for electrical components may be transistors, resistors, capacitors, coils, integrated circuits and/or inductors. Further, electrical components may also include terminals, connectors, switches, transducers, sensors, detectors, semiconductor devices and the like. The term “terminal” as used herein is to be understood as a connection between the wind turbine power output and a power grid. Typically, the terminal allows the electrical energy generated from the wind turbine to be received by the power grid. According to some embodiments, one or more terminals may be provided in a wind turbine generator.

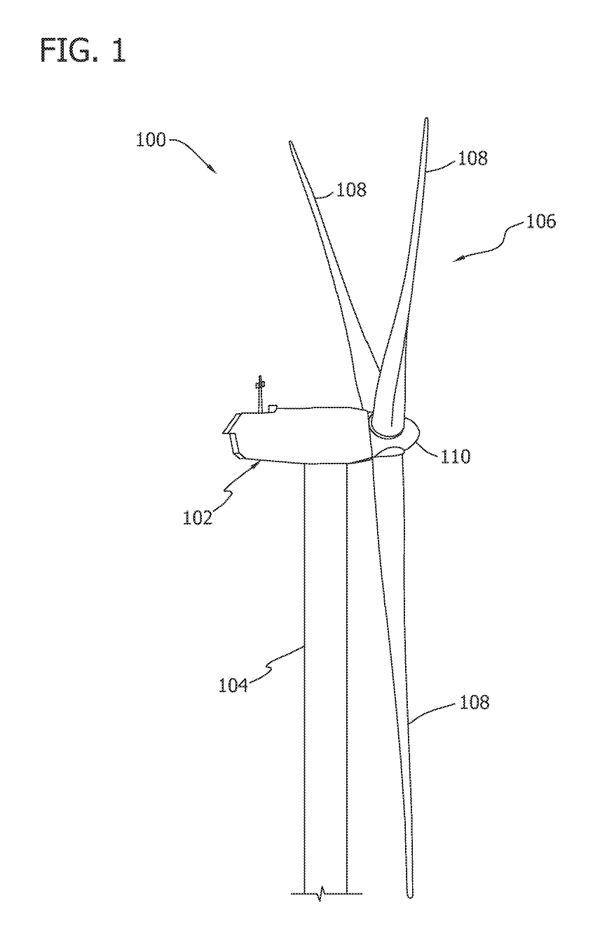

FIG. 1 is a perspective view of a portion of an exemplary wind turbine 100. Wind turbine 100 includes a nacelle 102 housing a generator (not shown in FIG. 1). Nacelle 102 is mounted on a tower 104 (a portion of tower 104 being shown in FIG. 1). Tower 104 may have any suitable height that facilitates operation of wind turbine 100 as described herein. Wind turbine 100 also includes a rotor 106 that includes three blades 108 attached to a rotating hub 110. Alternatively, wind turbine 100 includes any number of blades 108 that facilitates operation of wind turbine 100 as described herein. In the exemplary embodiment, wind turbine 100 includes a gearbox (not shown in FIG. 1) operatively coupled to rotor 106 and a generator (not shown in FIG. 1).

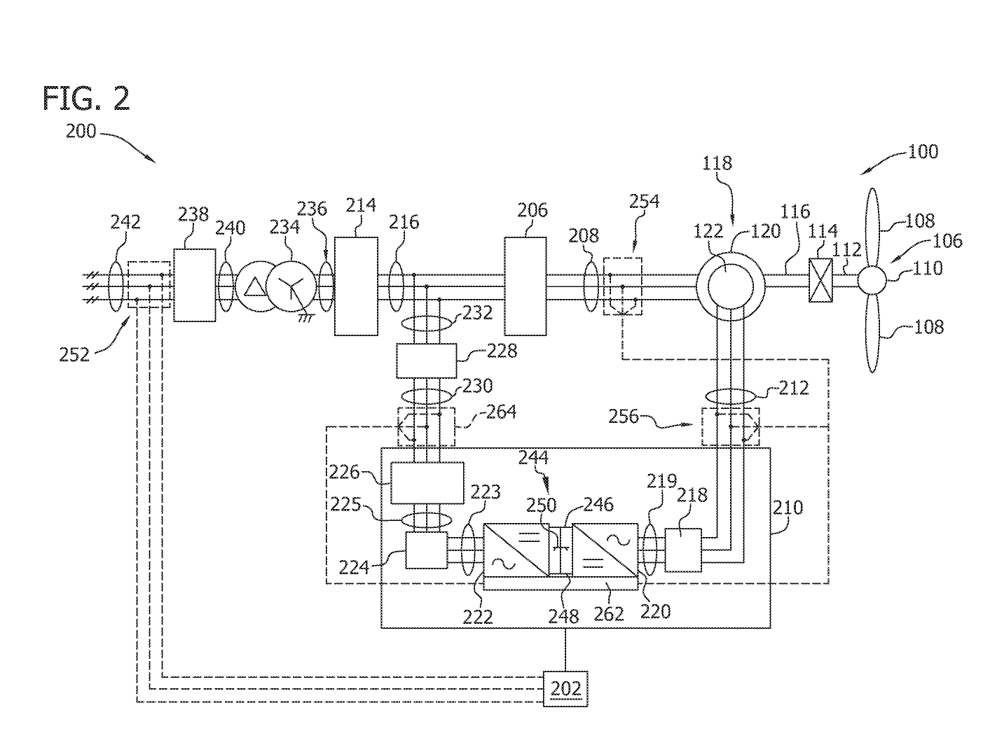

FIG. 2 is a schematic view of an exemplary electrical and control system 200 that may be used with wind turbine 100. Rotor 106 includes blades 108 coupled to hub 110. Rotor 106 also includes a low-speed shaft 112 rotatably coupled to hub 110. Low-speed shaft 112 is coupled to a step-up gearbox 114, which is configured to step up the rotational speed of low-speed shaft 112 and to transfer that speed to a high-speed shaft 116. In the exemplary embodiment, gearbox 114 has a step-up ratio of approximately 70:1. For example, low-speed shaft 112 rotating at approximately 20 revolutions per minute (rpm), coupled to gearbox 114 with an approximately 70:1 step-up ratio, generates a speed for high-speed shaft 116 of approximately 1400 rpm. Alternatively, gearbox 114 has any suitable step-up ratio that facilitates operation of wind turbine 100 as described herein. As a further alternative, wind turbine 100 includes a direct-drive generator that is rotatably coupled to rotor 106 without any intervening gearbox.

High-speed shaft 116 is rotatably coupled to generator 118. In the exemplary embodiment, generator 118 is a wound rotor, three-phase, double-fed induction (asynchronous) generator (DFIG) that includes a generator stator 120 magnetically coupled to a generator rotor 122.

Electrical and control system 200 includes a turbine controller 202. Turbine controller 202 includes at least one processor and a memory, at least one processor input channel, at least one processor output channel, and may include at least one computer (none shown in FIG. 2). As used herein, the term computer is not limited to integrated circuits referred to in the art as a computer, but broadly refers to a processor, a microcontroller, a microcomputer, a programmable logic controller (PLC), an application specific integrated circuit, and other programmable circuits (none shown in FIG. 2), and these terms are used interchangeably herein. In the exemplary embodiment, memory may include, but is not limited to, a computer-readable medium, such as a random access memory (RAM) (none shown in FIG. 2). Alternatively, one or more storage devices, such as a floppy disk, a compact disc read only memory (CD-ROM), a magneto-optical disk (MOD), and/or a digital versatile disc (DVD) (none shown in FIG. 2) may also be used. Also, in the exemplary embodiment, additional input channels (not shown in FIG. 2) may be, but are not limited to, computer peripherals associated with an operator interface such as a mouse and a keyboard (neither shown in FIG. 2). Further, in the exemplary embodiment, additional output channels may include, but are not limited to, an operator interface monitor (not shown in FIG. 2).

Processors for turbine controller 202 process information transmitted from a plurality of electrical and electronic devices that may include, but are not limited to, voltage and current transducers. RAM and/or storage devices store and transfer information and instructions to be executed by the processor. RAM and/or storage devices can also be used to store and provide temporary variables, static (i.e., non-changing) information and instructions, or other intermediate information to the processors during execution of instructions by the processors. Instructions that are executed include, but are not limited to, resident conversion and/or comparator algorithms. The execution of sequences of instructions is not limited to any specific combination of hardware circuitry and software instructions.

Generator stator 120 is electrically coupled to a stator synchronizing switch 206 via a stator bus 208. In an exemplary embodiment, to facilitate the DFIG configuration, generator rotor 122 is electrically coupled to a bi-directional power conversion assembly 210 via a rotor bus 212. Alternatively, generator rotor 122 is electrically coupled to rotor bus 212 via any other device that facilitates operation of electrical and control system 200 as described herein. As a further alternative, electrical and control system 200 is configured as a full power conversion system (not shown) that includes a full power conversion assembly (not shown in FIG. 2) similar in design and operation to power conversion assembly 210 and electrically coupled to generator stator 120. The full power conversion assembly facilitates channeling electric power between generator stator 120 and an electric power transmission and distribution grid (not shown). In the exemplary embodiment, stator bus 208 transmits three-phase power from generator stator 120 to stator synchronizing switch 206. Rotor bus 212 transmits three-phase power from generator rotor 122 to power conversion assembly 210. In the exemplary embodiment, stator synchronizing switch 206 is electrically coupled to a main transformer circuit breaker 214 via a system bus 216. In an alternative embodiment, one or more fuses (not shown) are used instead of main transformer circuit breaker 214. In another embodiment, neither fuses nor main transformer circuit breaker 214 is used.

Power conversion assembly 210 includes a rotor filter 218 that is electrically coupled to generator rotor 122 via rotor bus 212. A rotor filter bus 219 electrically couples rotor filter 218 to a rotor-side power converter 220 and rotor-side power converter 220 is electrically coupled to a line-side power converter 222. Rotor-side power converter 220 and line-side power converter 222 are power converter bridges including power semiconductors (not shown). In the exemplary embodiment, rotor-side power converter 220 and line-side power converter 222 are configured in a three-phase, pulse width modulation (PWM) configuration including insulated gate bipolar transistor (IGBT) switching devices (not shown in FIG. 2) that operate as known in the art. Alternatively, rotor-side power converter 220 and line-side power converter 222 have any configuration using any switching devices that facilitate operation of electrical and control system 200 as described herein. Power conversion assembly 210 is coupled in electronic data communication with turbine controller 202 to control the operation of rotor-side power converter 220 and line-side power converter 222.

In the exemplary embodiment, a line-side power converter bus 223 electrically couples line-side power converter 222 to a line filter 224. Also, a line bus 225 electrically couples line filter 224 to a line contactor 226. Moreover, line contactor 226 is electrically coupled to a conversion circuit breaker 228 via a conversion circuit breaker bus 230. In addition, conversion circuit breaker 228 is electrically coupled to main transformer circuit breaker 214 via system bus 216 and a connection bus 232. Alternatively, line filter 224 is electrically coupled to system bus 216 directly via connection bus 232 and includes any suitable protection scheme (not shown) configured to account for removal of line contactor 226 and conversion circuit breaker 228 from electrical and control system 200. Main transformer circuit breaker 214 is electrically coupled to an electric power main transformer 234 via a generator-side bus 236. Main transformer 234 is electrically coupled to a grid circuit breaker 238 via a breaker-side bus 240. Grid circuit breaker 238 is connected to the electric power transmission and distribution grid via a grid bus 242. In an alternative embodiment, main transformer 234 is electrically coupled to one or more fuses (not shown), rather than to grid circuit breaker 238, via breaker-side bus 240. In another embodiment, neither fuses nor grid circuit breaker 238 is used, but rather main transformer 234 is coupled to the electric power transmission and distribution grid via breaker-side bus 240 and grid bus 242.

In the exemplary embodiment, rotor-side power converter 220 is coupled in electrical communication with line-side power converter 222 via a single direct current (DC) link 244. Alternatively, rotor-side power converter 220 and line-side power converter 222 are electrically coupled via individual and separate DC links (not shown in FIG. 2). DC link 244 includes a positive rail 246, a negative rail 248 and at least one capacitor 250 coupled between positive rail 246 and negative rail 248. Alternatively, capacitor 250 includes one or more capacitors configured in series and/or in parallel between positive rail 246 and negative rail 248.

Turbine controller 202 is configured to receive a plurality of voltage and electric current measurement signals from a first set of voltage and electric current sensors 252. Moreover, turbine controller 202 is configured to monitor and control at least some of the operational variables associated with wind turbine 100. In the exemplary embodiment, each of three voltage and electric current sensors 252 are electrically coupled to each one of the three phases of grid bus 242. Alternatively, voltage and electric current sensors 252 are electrically coupled to system bus 216. As a further alternative, voltage and electric current sensors 252 are electrically coupled to any portion of electrical and control system 200 that facilitates operation of electrical and control system 200 as described herein. As a still further alternative, turbine controller 202 is configured to receive any number of voltage and electric current measurement signals from any number of voltage and electric current sensors 252 including, but not limited to, one voltage and electric current measurement signal from one transducer.

As shown in FIG. 2, electrical and control system 200 also includes a converter controller 262 that is configured to receive a plurality of voltage and electric current measurement signals. For example, in one embodiment, converter controller 262 receives voltage and electric current measurement signals from a second set of voltage and electric current sensors 254 coupled in electronic data communication with stator bus 208. Converter controller 262 receives a third set of voltage and electric current measurement signals from a third set of voltage and electric current sensors 256 coupled in electronic data communication with rotor bus 212. Converter controller 262 also receives a fourth set of voltage and electric current measurement signals from a fourth set of voltage and electric current sensors 264 coupled in electronic data communication with conversion circuit breaker bus 230. Second set of voltage and electric current sensors 254 is substantially similar to first set of voltage and electric current sensors 252, and fourth set of voltage and electric current sensors 264 is substantially similar to third set of voltage and electric current sensors 256. Converter controller 262 is substantially similar to turbine controller 202 and is coupled in electronic data communication with turbine controller 202. Moreover, in the exemplary embodiment, converter controller 262 is physically integrated within power conversion assembly 210. Alternatively, converter controller 262 has any configuration that facilitates operation of electrical and control system 200 as described herein.

During operation, wind impacts blades 108 and blades 108 transform wind energy into a mechanical rotational torque that rotatably drives low-speed shaft 112 via hub 110. Low-speed shaft 112 drives gearbox 114 that subsequently steps up the low rotational speed of low-speed shaft 112 to drive high-speed shaft 116 at an increased rotational speed. High speed shaft 116 rotatably drives generator rotor 122. A rotating magnetic field is induced by generator rotor 122 and a voltage is induced within generator stator 120 that is magnetically coupled to generator rotor 122. Generator 118 converts the rotational mechanical energy to a sinusoidal, three-phase alternating current (AC) electrical energy signal in generator stator 120. The associated electrical power is transmitted to main transformer 234 via stator bus 208, stator synchronizing switch 206, system bus 216, main transformer circuit breaker 214 and generator-side bus 236. Main transformer 234 steps up the voltage amplitude of the electrical power and the transformed electrical power is further transmitted to a grid via breaker-side bus 240, grid circuit breaker 238 and grid bus 242.

In the exemplary embodiment, a second electrical power transmission path is provided. Electrical, three-phase, sinusoidal, AC power is generated within generator rotor 122 and is transmitted to power conversion assembly 210 via rotor bus 212. Within power conversion assembly 210, the electrical power is transmitted to rotor filter 218 and the electrical power is modified for the rate of change of the PWM signals associated with rotor-side power converter 220. Rotor-side power converter 220 acts as a rectifier and rectifies the sinusoidal, three-phase AC power to DC power. The DC power is transmitted into DC link 244. Capacitor 250 facilitates mitigating DC link 244 voltage amplitude variations by facilitating mitigation of a DC ripple associated with AC rectification.

The DC power is subsequently transmitted from DC link 244 to line-side power converter 222 and line-side power converter 222 acts as an inverter configured to convert the DC electrical power from DC link 244 to three-phase, sinusoidal AC electrical power with pre-determined voltages, currents, and frequencies. This conversion is monitored and controlled via converter controller 262. The converted AC power is transmitted from line-side power converter 222 to system bus 216 via line-side power converter bus 223 and line bus 225, line contactor 226, conversion circuit breaker bus 230, conversion circuit breaker 228, and connection bus 232. Line filter 224 compensates or adjusts for harmonic currents in the electric power transmitted from line-side power converter 222. Stator synchronizing switch 206 is configured to close to facilitate connecting the three-phase power from generator stator 120 with the three-phase power from power conversion assembly 210.

Conversion circuit breaker 228, main transformer circuit breaker 214, and grid circuit breaker 238 are configured to disconnect corresponding buses, for example, when excessive current flow may damage the components of electrical and control system 200. Additional protection components are also provided including line contactor 226, which may be controlled to form a disconnect by opening a switch (not shown in FIG. 2) corresponding to each line of line bus 225.

Power conversion assembly 210 compensates or adjusts the frequency of the three-phase power from generator rotor 122 for changes, for example, in the wind speed at hub 110 and blades 108. Therefore, in this manner, mechanical and electrical rotor frequencies are decoupled from stator frequency.

The DC power is subsequently transmitted from DC link 244 to rotor-side power converter 220 and rotor-side power converter 220 acts as an inverter configured to convert the DC electrical power transmitted from DC link 244 to a three-phase, sinusoidal AC electrical power with pre-determined voltages, currents, and frequencies. This conversion is monitored and controlled via converter controller 262. The converted AC power is transmitted from rotor-side power converter 220 to rotor filter 218 via rotor filter bus 219 and is subsequently transmitted to generator rotor 122 via rotor bus 212, thereby facilitating sub-synchronous operation.

Power conversion assembly 210 is configured to receive control signals from turbine controller 202. The control signals are based on sensed conditions or operating characteristics of wind turbine 100 and electrical and control system 200. The control signals are received by turbine controller 202 and used to control operation of power conversion assembly 210. Feedback from one or more sensors may be used by electrical and control system 200 to control power conversion assembly 210 via converter controller 262 including, for example, a conversion circuit breaker bus 230, stator bus and rotor bus voltages or current feedbacks via second set of voltage and electric current sensors 254, third set of voltage and electric current sensors 256, and fourth set of voltage and electric current sensors 264. Using this feedback information, and, for example, switching control signals, stator synchronizing switch control signals and system circuit breaker control (trip) signals may be generated in any known manner. For example, for a grid voltage transient with predetermined characteristics, converter controller 262 will at least temporarily substantially suspend the IGBTs from conducting within line-side power converter 222. Such suspension of operation of line-side power converter 222 will substantially mitigate electric power being channeled through power conversion assembly 210 to approximately zero.

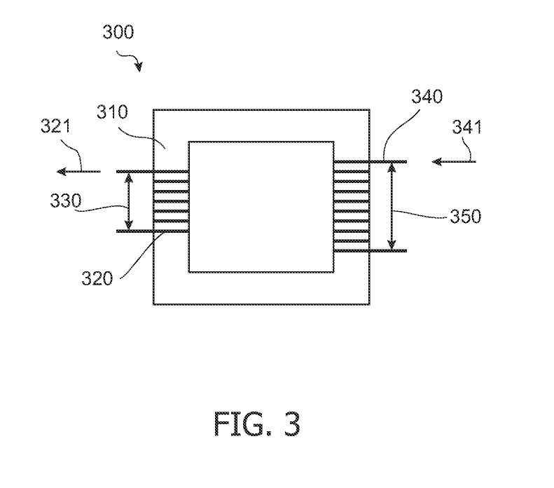

FIG. 3 shows a schematic view of a transformer. Generally, the transformer 300 includes a transformer core 310, which may be made of a ferromagnetic material, such as steel, ferrite, alloys thereof, or the like. Typically, the transformer core provides a magnetic circle. The transformer 300 includes a primary winding 340 and a secondary winding 320. The primary winding 340 and the secondary winding 320 may be made of a conductive material, such as copper, aluminum or the like. The primary winding 340 and the secondary winding 320 may include a wire being wound or wound around the transformer core 310. The number of turns of a winding around the transformer core depends on the intended operation of the transformer and influences the ratio of the voltages of the primary winding 340 and the secondary winding 320. For instance, a current 341 is supplied to the first winding 340 with a first voltage 350, which—being dependent on the number of turns in the windings—results in a second voltage 330 at the secondary winding with the second current 321.

Generally, the voltage level of the complete electrical equipment within the wind turbine is limited to a feasible range during operation due to constructional and cost-related reasons. Therefore, the risk of damage to any electrical component in the wind turbine or tripping of protection devices is reduced by using the arrangement described herein. Increasing the rating or protection level of each and every single component in the wind turbine is therefore not needed. However, as some power grid codes require strong overvoltage capabilities, a wind turbine undergoes several overvoltage or low voltage events during the lifetime of the wind turbine. Reasons for an over-voltage or under-voltage event in the grid are for example the switching of big loads or failures like short circuits.

Using transformer tab changers for influencing the voltage in the transformer is known in the art. However, the tab changers are not fast enough to change the voltage level for fast changing voltage events, especially for overvoltage events. They are designed for slowly changing voltage in a smaller range for continuous operation. In general, the requirement for the tab changers is to run through longer events. Tab changers are limited to certain steps, too.

A transformer according to embodiments described herein includes an additional winding inside of the main transformer of the wind turbine. The additional winding may be provided in different ways, as described in detail in the following. Generally, the additional winding is supposed to create either an opposing field within the transformer, which reduces the voltage at the secondary side of the transformer, or drives the transformer to saturation and therefore limits secondary voltage. Generally, in the figures describing embodiments of the invention, single phase transformers are shown for the sake of simplicity and a better understanding. However, it should be understood that most transformers used in wind turbine applications to connect the wind turbine to the utility grid are three phase transformers. The embodiments described herein may thus also applied to three-phase transformers.

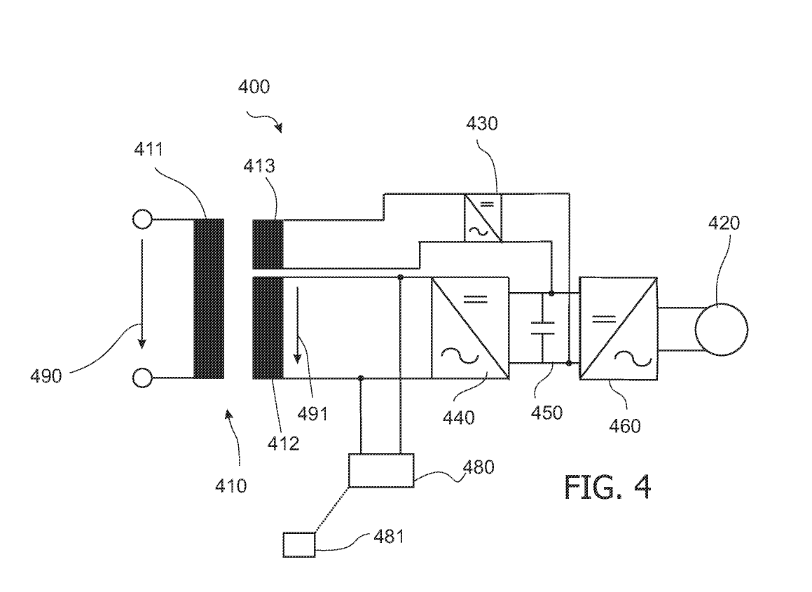

An example of a transformer arrangement according to embodiments described herein is shown in FIG. 4. The transformer arrangement 400 for a wind energy system includes a first transformer 410. Typically, the first transformer 410 includes a transformer core (not shown in FIG. 4), a primary winding 411 and a first secondary winding 412. According to some embodiments, the primary winding and the secondary winding may be windings as described with respect to FIG. 3. For instance, the primary winding 411 and the first secondary winding 412 may be made of a copper wire, an aluminum wire or the like.

According to some embodiments, the first secondary winding 412 may be adapted for being connected to the generator 420 of the wind turbine. Arrow 491 indicates the voltage of the wind turbine side applied to the first secondary winding 412. Also, the first secondary winding may be described as being adapted for being connected to a power source. Typically, the first secondary winding 412 is connected to a power source, such as generator 420, via further components, such as inverters 440, 460 and DC-links or DC-link capacitor 450. According to some embodiments described herein, the primary winding 411 may be adapted for being connected to a power grid, which receives the energy of the wind turbine in order to distribute the electrical energy. Typically, the primary winding may be described as being adapted for being connected to an electrical load, such as a power grid leading to the power consumers. Also, the primary winding may be adapted for being connected to a power consumer. Arrow 490 indicates the voltage of the grid applied to the primary winding 411.

Generally, a transformer arrangement as described herein may include a control system for controlling at least the first transformer. The control system may be part of the control system of the wind turbine (as described above with respect to FIG. 2). Details of the control system of the transformer arrangement according to embodiments described herein are described below.

According to some embodiments, the transformer 410 may be connected to a signal device or control system 480 providing signals, such as control signals to the transformer 410. Typically, the signal device or control system providing signals for the operation of the transformer is able to receive and process data from a voltage sensor device 481. The sensor device 481 is adapted for sensing the voltage in electrical components of the wind energy system, in the terminals of the wind energy system and/or the power grid connected to the wind energy system. According to some embodiments, the measured values of the voltage may be communicated to the control system via a bus system, as exemplarily described above. Typically, the voltage measurement may take place in a converter of the wind energy system. The measurement of the voltage may be performed in an analogue or a digital manner. Also, to provide measured voltage values, sensor devices already present in the wind energy system may be used, such as a voltage sensor in a converter. According to some embodiments, a sensor device may include distinct measurement points in order to provide data to detect a deviation from a normal voltage level.

Typically, the transformer arrangement as described herein may include at least a part of a second secondary winding. For instance, transformer arrangement 400 includes a second secondary winding 413. According to some embodiments, the second secondary winding may be adapted for being connected to a power source 420 and may be adapted for influencing the voltage of the first secondary winding and/or the voltage applied to the electrical components of the wind turbine.

Typically, influencing the voltage of the first secondary winding and/or the voltage applied to the electrical components of the wind turbine in this context may be understood as reducing the voltage of the first secondary winding and/or the voltage applied to the electrical components of the wind turbine.

Typically, the second secondary winding as described herein may be a separate winding, which may be optionally operated in the case of overvoltage. According to some embodiments described herein, the second secondary winding may separately be controlled. Generally, the second secondary winding may be operated additionally to the first secondary winding. For instance, the second secondary winding is operated in the case of overvoltage additionally to the standard operation of the first secondary winding (i.e., the operation at a time, where no overvoltage event occurs).

In the embodiment shown in FIG. 4, the second secondary winding 413 is connected to a power source 420 by an inverter 430. Thus, the second secondary winding 413 may be described as being supplied by the inverter 430. Generally, the second secondary winding can be sourced by an inverter or by a passive circuit, depending on the existing grid voltage, as will be explained in detail below.

According to some embodiments, the second secondary winding 413 may be arranged or wound around the transformer core of the first transformer 410. Typically, the second secondary winding 413 may be arranged on the same bracket of the transformer core as the first secondary winding 411 or may be arranged on the same bracket of the transformer core as the primary winding 411. According to other embodiments, the second secondary winding may be part of the first secondary winding. That means that the second secondary winding is a part of the first secondary winding, which has an additional power supply, such as the power supply via inverter 430 in FIG. 4.

Typically, the second secondary winding may be inversely arranged to the first secondary winding, i.e. the second secondary winding may be arranged in an opposite way to the first secondary winding.

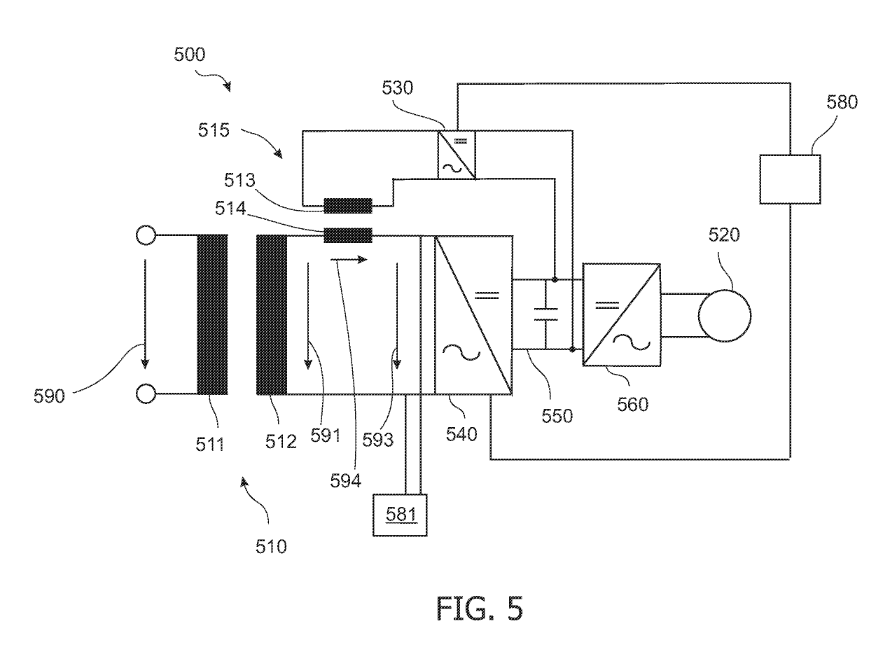

FIG. 5 shows a transformer arrangement according to embodiments described herein. The transformer arrangement 500 includes a first transformer 510 having a primary winding 511and a first secondary winding 512. Typically, the primary winding 511 and the first secondary winding 512 may be designed as described above with respect to FIGS. 3 and 4. The first secondary winding 512 of the first transformer may be connected to a power supply, such as generator 520. According to some embodiments, the first secondary winding 512 of the first transformer 510 may be connected to the power source 520 via inverters 540 and 560 and a DC-link 550. Arrow 591 indicates the voltage of the wind turbine side applied to the first secondary winding 512 of the first transformer 510, and arrow 590 indicates the voltage of the grid applied to the primary winding 511.

In the embodiment shown in FIG. 5, the second secondary winding of the transformer arrangement 500 is located in a second transformer 515. The second transformer 515 may include a primary winding 514 and a secondary winding 513. Typically, the primary winding 514 of the second transformer 515 may influence the voltage at the wind turbine terminals, i.e. the voltage applied to the electrical components of the wind turbine. According to some embodiments, the second transformer 515 may be supplied by power source 520 and may be connected to the power source 520 via an inverter 530. By operating the secondary winding 513 of the second transformer 515, the voltage of the primary winding 514 of the second transformer 515 may be influenced. Typically, the primary winding 514 of the second transformer 515 is arranged so as to influence the voltage applied to the electrical components of the wind turbine. Typically, the secondary winding of the first transformer may be denoted as being the first secondary winding of the transformer arrangement 500.

According to some embodiments, the second transformer 515 is arranged in series to the first transformer 510 in order to provide the above described characteristic. In the embodiments shown in FIG. 5, it can exemplarily be seen that electrical components 581 are connected to the voltage influenced by the transformer arrangement. Typically, the electrical components 581 are also protected by the transformer arrangement of FIG. 5. For instance, electrical components 581, such as auxiliaries, are protected by the transformer arrangement in the case of over-voltage. Arrow 594 indicates the voltage at the winding 514, and arrow 593 indicates the voltage at the wind turbine terminals.

According to some embodiments, which may be combined with other embodiments described herein, the control of the windings of the transformer arrangement (i.e., the first secondary winding and the second secondary winding) may be controlled by a control system 580 capable of influencing the operation of the windings of the transformer arrangement. As can exemplarily be seen in FIG. 5, the inverters 530 and 540 of the transformer arrangement are controlled by the same control system, i.e. control system 580. Typically, the control system 580 may be the control system of the wind turbine as described above with respect to FIG. 2, it may also be a part of the control system of the wind turbine as described above with respect to FIG. 2, or it may be an additional control system to the control system of the wind turbine as described above with respect to FIG. 2, or it may be part of the control system of the power converter (540 and 560) of the wind turbine.

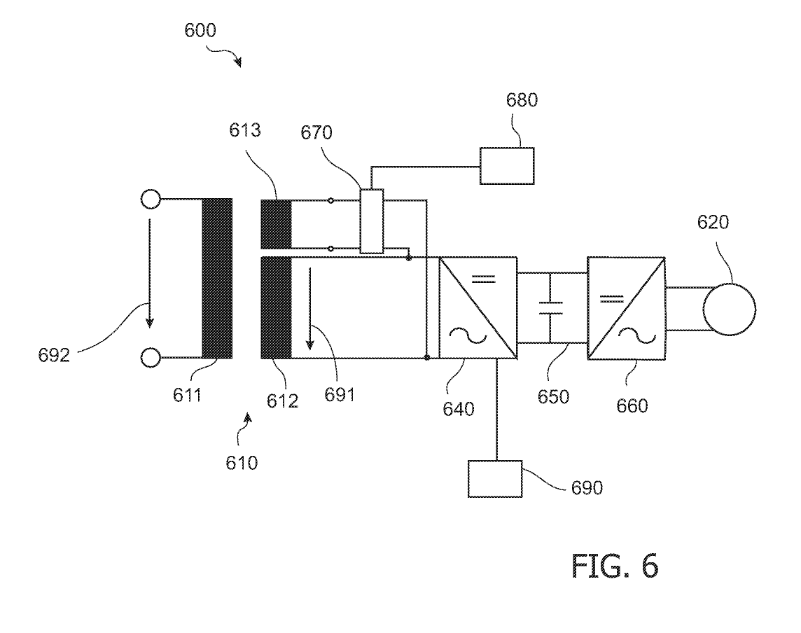

FIG. 6 shows an embodiment of a transformer arrangement, where the second secondary winding is controlled by a separate control system. The transformer arrangement 600 includes a first transformer 610 having a primary winding 611 and a secondary winding 612 (i.e., a first secondary winding 612 of the transformer arrangement 600). Arrow 691 indicates the voltage of the wind turbine side applied to the first secondary winding 612, and arrow 692 indicates the voltage of the grid applied to the primary winding 611. Further, the transformer arrangement 600 includes a second secondary winding 613, which is exemplarily shown as being arranged on the same transformer core of the first transformer 600 as the primary winding 611 and the first secondary winding 612. Alternatively, the second secondary winding 613 may also be arranged in a second transformer, as described with respect to FIG. 5.

In FIG. 6, the second secondary winding 613 is controlled by a separate control system 680. That means that the control system 680 is a different control system than the control system 690 controlling the first secondary winding of the transformer arrangement. The separate control system 680 may be a control system controlling the operation and the energy supply of the second secondary winding. For instance, the control system 680 may influence the operation of the second secondary winding 613 via a transistor device 670. Typically, the control systems 680 and 690 may be part of a control system of the wind turbine as described with respect to FIG. 2.

According to some embodiments, the voltage and/or current applied to the second secondary winding or to a part of the winding can exemplarily be controlled depending on the grid voltage level, the DC link voltage or another measured value. For this purpose, respective sensors may be located and connected (e.g., as part of the power converter control system or the wind turbine control system) so as to be able to trigger the desired control action. Typically, data from the sensors is transmitted to the control system to calculate and/or trigger control actions.

According to further embodiments, which may be combined with other embodiments described herein, a passive circuit may be used in order to control the operation of the windings of the transformer arrangement. Typically, the passive circuit may energize the circuit directly depending on the transformer primary side voltage level, the DC link voltage or another measured value, without additional control.

In the case that an inverter is used (such as inverters 430, 440, 530, and 540 in the examples shown in FIGS. 4 and 5), the voltage at the secondary side of the transformer may be controlled in a certain range during the event. In the case that a passive circuit is used for controlling the transformer arrangement, there is no direct control of the voltage in an event, the control may only be performed by the design of the circuit. Typically, the passive circuit may be easier to install, more robust and less costly. According to some embodiments, both solutions create very limited additional losses, so that the annual energy production (AEP) of the wind turbine is almost unaffected.

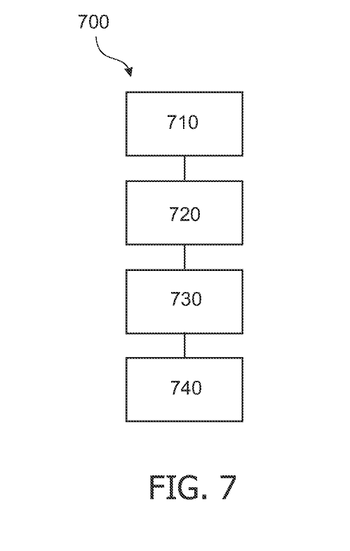

According to a further embodiment described herein, a method for controlling a voltage in a transformer of a transformer arrangement in a wind energy system is provided. FIG. 7 shows a flow chart of an embodiment as described herein. The method 700 includes block 710, in which a primary winding of the transformer of the transformer arrangement is connected to an electrical load according to embodiments described herein. Typically, the primary winding is wound around the same transformer core as a first secondary winding of the transformer. According to some embodiments, the primary winding may be a primary winding of the transformer as described with respect to FIGS. 3 to 6.

In block 720, the voltage applied to the electrical components of the wind turbine is monitored to sense an overvoltage event. The monitoring of the voltage may be performed by measuring the voltage in electrical components of the wind energy system, the terminals of the wind energy system and/or the power grid to which the wind energy system is connected. After measuring, the data obtained by the measurement may be communicated to a control system. The control system may be able to process the data, for instance, to compare the data of measured voltage values with a given parameter or other voltage data. The control system may process the received data in order to determine whether or not a control signal or a control function is appropriate. In other words, the control system may give respective signals so that the voltage level in the electrical components of the wind energy system may be held at a defined level.

According to some embodiments, the control system is able to give signals to the transformer of the wind energy system. The signals may allow the following steps to be performed.

In block 730, a first secondary winding of the transformer is energized for creating a first energy field. Typically, the first secondary winding is wound around a transformer core of a first transformer, as for instance described in FIG. 3. According to some embodiments, the first secondary winding is adapted for being connected to a power source, such as a generator of a wind turbine. Generally, further components may be arranged between the generator and the first secondary winding, such as a controllable inverter, as exemplarily shown in FIG. 4.

In block 740, a second secondary winding of the transformer arrangement is energized in order to influence the voltage in the first secondary winding and/or directly influencing the voltage applied to the electrical components of the wind turbine. Typically, the second secondary winding may be provided in different ways, such as in the main transformer of the wind turbine or maybe as a part of an existing winding (e.g., the first secondary winding). According to further embodiments described herein, the additional winding may be provided in a second transformer of the transformer arrangement as exemplarily described with respect to FIG. 5. The additional winding, or part of winding, (i.e., the second secondary winding) may be energized by, for example, an inverter, which is coupled to the existing DC link of the turbine frequency converter or to a rectifier, which is then connected to the secondary side of the transformer.

Typically, the operation of the second secondary winding may be controlled by a control system of the transformer of the transformer arrangement, as already described in detail above with respect to FIG. 5 and with respect to block 720. In this way, the additional winding, such as the second secondary winding, may easily be added to an existing transformer arrangement of a wind turbine. In another embodiment, the second secondary winding is controlled by an additional control system of the transformer arrangement for the second secondary winding, such as the control system 680 in FIG. 6.

According to some embodiments, controlling the second secondary winding of the transformer arrangement includes creating an opposing field to the first energy field within the transformer for reducing the voltage in the secondary winding. For instance, the second secondary winding is supposed to create an opposing field in the transformer to reduce the secondary side voltage of the transformer during overvoltage events. Typically, overvoltage events are sensed by monitoring the voltage in the electrical components of the wind energy system. According to further embodiments described herein, the second secondary winding of the transformer arrangement is controlled so as to limit the secondary voltage by driving the transformer to saturation. The saturation of the transformer is typically a matter of the used materials for the core. Generally, the core can handle a certain maximum of magnetic flux. If the flux get's higher than the maximum, the functionality of “conducting” the magnetic flux ends. A saturation of the core may occur with feeding DC voltage into a winding.

Typically, the second secondary winding is energized at the appearance of overvoltage. For instance, by using the method according to embodiments described herein, it is possible to react on an overvoltage event in the range of microseconds or even less. Additionally, it is possible to influence the voltage of the second secondary winding for a time period in the range of about several ten milliseconds by sizing the arrangement respectively. Alternatively, the system according to some embodiments described herein may be designed to work continuously.

Normal overvoltage protection is only designed for very short, relatively high voltage spikes (such as a few hundred microseconds), but not for overvoltage events, which last several tenths of milliseconds. The transformer arrangement according to embodiments described herein allows for a quick, reliable and easily controllable reaction on overvoltage events. Also, as the existing transformer arrangement in the wind turbine and the existing equipment of the wind turbine (such as control systems and the like) may be used, the overvoltage control of the wind turbine is very cost-effective.

The above-described systems and methods facilitate the overvoltage control of a transformer in a wind turbine. More specifically, the transformer arrangement, according to embodiments described herein, allows for counteracting overvoltage events in an easy and cost-effective way by using existing equipment of the transformer arrangement and the wind turbine control or the control of the power converter.

Exemplary embodiments of systems and methods for a transformer arrangement for a wind turbine are described above in detail. The systems and methods are not limited to the specific embodiments described herein, but rather, components of the systems and/or steps of the methods may be utilized independently and separately from other components and/or steps described herein. For example, the transformer arrangement and the method for controlling a voltage in a wind turbine as described herein, are not limited to practice with only the wind turbine systems as described herein. Rather, the exemplary embodiment can be implemented and utilized in connection with many other rotor blade applications. Further, embodiments described herein can be used not only for wind turbine applications, but for a wide range of applications. In general, any transformer arrangement, coupled to the grid can be equipped with this to reduce the effect of grid over-voltage and/or even under-voltage.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allow for equally effective modifications. Especially, mutually non-exclusive features of the embodiments described above may be combined with each other. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A transformer arrangement for controlling an overvoltage event in a wind energy system including electrical components, comprising:
a) a first transformer including
i) a transformer core;
ii) a primary winding wound around the transformer core and adapted for being connected to an electrical load; and,
iii) a first secondary winding wound around the transformer core and adapted for being connected to a first power source;
b) a control system for controlling the first transformer; and,
c) a second secondary winding adapted for being connected to a second power source and adapted for reducing at least one of the voltage of the first secondary winding and the voltage applied to the electrical components of the wind turbine in the case of an overvoltage event.

2. The transformer arrangement according to claim 1, wherein the second secondary winding is adapted to reduce the voltage at the terminals of the wind turbine generator.

3. The transformer arrangement according to claim 1, wherein the second secondary winding is wound around the transformer core of the first transformer.

4. The transformer arrangement according to claim 1, wherein the second secondary winding is located in a second transformer.

5. The transformer arrangement according to claim 4, wherein the second transformer is arranged in series to the first transformer.

6. The transformer arrangement according to claim 1, wherein the second secondary winding is part of the first secondary winding.

7. The transformer arrangement according to claim 1, wherein the second secondary winding is controlled by the control system of the first transformer.

8. The transformer arrangement according to claim 7, wherein the second secondary winding is controlled by an inverter of the wind energy system.

9. The transformer arrangement according to claim 1, wherein the first power source and the second power source are the same power source.

10. A wind energy system including a rotor, a generator being connected to the rotor, and a terminal for connecting the wind energy system with a power grid, comprising:
a) a transformer for reducing the voltage at the terminal including a transformer core, a primary winding wound around the transformer core and being connected to an electrical load, and a first secondary winding wound around the transformer core and adapted for being connected to the generator;
b) a winding device including at least one winding for reducing at least one of the voltage of the first secondary winding and the voltage applied to the terminal of the wind turbine, wherein the device is adapted for being connected to a power source;
c) a sensor device adapted for sensing an overvoltage event occurring in the wind energy system; and,
d) a control system adapted for communicating with the sensor device and adapted for controlling the operation of at least one of the first secondary winding and the winding device in the case of an overvoltage event.

11. The wind energy system according to claim 10, wherein the winding device is controlled by the same control system controlling the first secondary winding.

12. The wind energy system according to claim 10, further comprising a second control system for controlling the operation of the winding device.

13. The wind energy system according to claim 10, wherein the winding device is a second secondary winding of the transformer wound around the transformer core.

14. The wind energy system according to claim 10, wherein the winding device is a second transformer.

15. Method for controlling an overvoltage event in a transformer of a transformer arrangement of a wind energy system including electrical components, comprising:
a) providing a connection of a primary winding of the transformer to an electrical load;
b) monitoring the voltage applied to the electrical components of the wind turbine to sense an overvoltage event;
c) energizing a first secondary winding of the transformer for creating a first energy field; and,
d) energizing a second secondary winding of the transformer arrangement for reducing at least one of the voltage of the first secondary winding and the voltage applied to the electrical components of the wind turbine in the case of an overvoltage event.

16. The method according to claim 15, further comprising controlling the second secondary winding of the transformer arrangement.

17. The method according to claim 16, wherein the second secondary winding is controlled by a control system of the transformer of the transformer arrangement.

18. The method according to claim 16, wherein the second secondary winding is controlled by an additional control system of the transformer arrangement for the second secondary winding.

19. The method according to claim 15, wherein controlling the second secondary winding of the transformer arrangement includes at least one of creating an opposing field to the first energy field within the transformer for reducing the voltage in the first secondary winding, and limiting the secondary voltage by driving the transformer to saturation.

20. The method according to claim 15, wherein the voltage applied to the electrical components of the wind turbine is monitored by a sensor device of the wind energy system.
